(19) United States
(12) Patent Application Publication
(10) Pub. No.: US 2013/0159930 A1
(43) Pub. Date: Jun. 20, 2013

(54) DISPLAYING ONE OR MORE CURRENTLY ACTIVE APPLICATIONS

(71) Applicants: Christopher Paretti, San Francisco, CA (US); William Lindmeier, San Francisco, CA (US); Amber Reed, San Francisco, CA (US)

(72) Inventors: Christopher Paretti, San Francisco, CA (US); William Lindmeier, San Francisco, CA (US); Amber Reed, San Francisco, CA (US)

(73) Assignee: NOKIA CORPORATION, Espoo (FI)

(21) Appl. No.: 13/330,011

(22) Filed: Dec. 19, 2011

(51) Int. Cl. G06F 3/048; G06F 3/041

(52) U.S. Cl. 715/821

(57) ABSTRACT

Methods, apparatuses, and computer program products are herein provided for displaying currently active applications. A method may include receiving user input. The method may further include determining, by a processor, a list of applications. The list of applications may comprise at least one currently active application. The method may further include causing display of the list of applications in response to receiving the user input, wherein causing display of the list of applications comprises causing display of at least one first application above at least one second application. Corresponding apparatuses and computer program products are also provided.

### TECHNOLOGICAL FIELD

Example embodiments of the present invention relate generally to user interface technology and, more particularly, relate to methods, apparatuses, and computer program products for displaying a list of one or more currently active applications.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Increased functionality of mobile computing devices has enabled mobile computing devices to store and perform more functions (e.g., applications). In particular, mobile computing devices may run a number of different applications at the same time. Additionally, mobile computing devices have developed display formats (e.g., homescreens) that show representations (e.g., icons) of some of the available applications.

### BRIEF SUMMARY

Embodiments of the present invention provide methods, apparatuses, and computer program products for displaying a list of one or more currently active applications. The list of applications can be quickly displayed in a user friendly list format that assists the user in viewing and managing the currently active applications.

In one example embodiment, a method includes receiving user input. The method further includes determining, by a processor, a list of applications, wherein the list of applications comprises at least one currently active application. The method further includes causing display of the list of applications in response to receiving the user input, wherein causing display of the list of applications comprises causing display of at least one first application above at least one second application.

In another example embodiment, an apparatus comprising at least one processor and at least one memory storing computer program code, wherein the at least one memory and stored computer program code are configured, with the at least one processor, to cause the apparatus to receive user input. The at least one memory and stored computer program code are configured, with the at least one processor, to further cause the apparatus to determine a list of applications, wherein the list of applications comprises at least one currently active application. The at least one memory and stored computer program code are configured, with the at least one processor, to further cause the apparatus to cause display of the list of applications in response to receiving the user input, wherein causing display of the list of applications comprises causing display of at least one first application above at least one second application.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method comprising receiving user input. The method further includes determining a list of applications, wherein the list of applications comprises at least one currently active application. The method further includes causing display of the list of applications in response to receiving the user input, wherein causing display of the list of applications comprises causing display of at least one first application above at least one second application.

In another example embodiment, an apparatus is provided. The apparatus comprises means for receiving user input. The apparatus further includes a means for determining a list of applications, wherein the list of applications comprises at least one currently active application. The apparatus further includes a means for causing display of the list of applications in response to receiving the user input, wherein causing display of the list of applications comprises causing display of at least one first application above at least one second application.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus with a user interface according to an example embodiment;

FIG. 2 is a schematic block diagram of a mobile terminal according to an example embodiment;

FIGS. 3A-3B illustrate example user inputs (e.g., gestures) indicating desired operation of a function on an apparatus, such as the apparatus illustrated in FIG. 1, in accordance with example embodiments described herein;

FIG. 4A illustrates an example display for an apparatus, such as the apparatus illustrated in FIG. 1, wherein the display includes icons representing applications for the apparatus, in accordance with example embodiments described herein;

FIG. 4B illustrates an example user input on the display of the apparatus illustrated in FIG. 4A, wherein the user input defines a swipe gesture originating from the edge of the display, in accordance with example embodiments described herein;

FIG. 4C illustrates an example displayed list of currently active applications, wherein the list of currently active applications is displayed in response to receiving the user input illustrated in FIG. 4B, in accordance with example embodiments described herein;

FIG. 4D illustrates another example user input directed toward at least one list bar of the displayed list of currently active applications illustrated in FIG. 4C, in accordance with example embodiments described herein;

FIG. 5 illustrates a flowchart according to an example method for displaying a list of currently active applications, in accordance with example embodiments described herein; and

FIG. 6 illustrates a flowchart according to another example method for displaying a list of currently active applications, in accordance with example embodiments described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

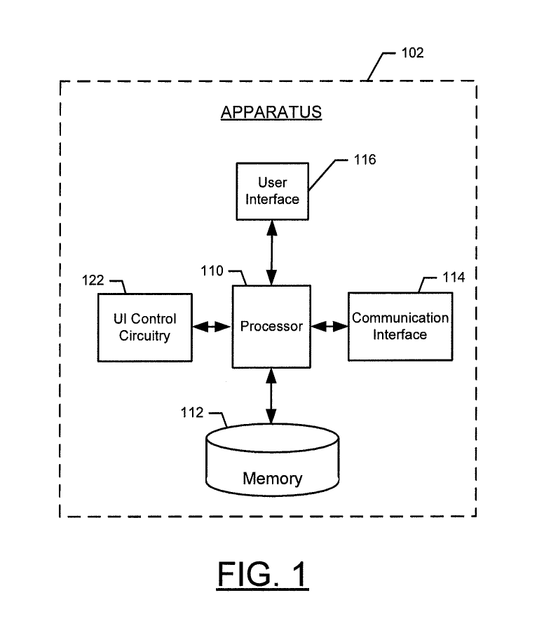

FIG. 1 illustrates a block diagram of an apparatus 102 for facilitating interaction with a user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

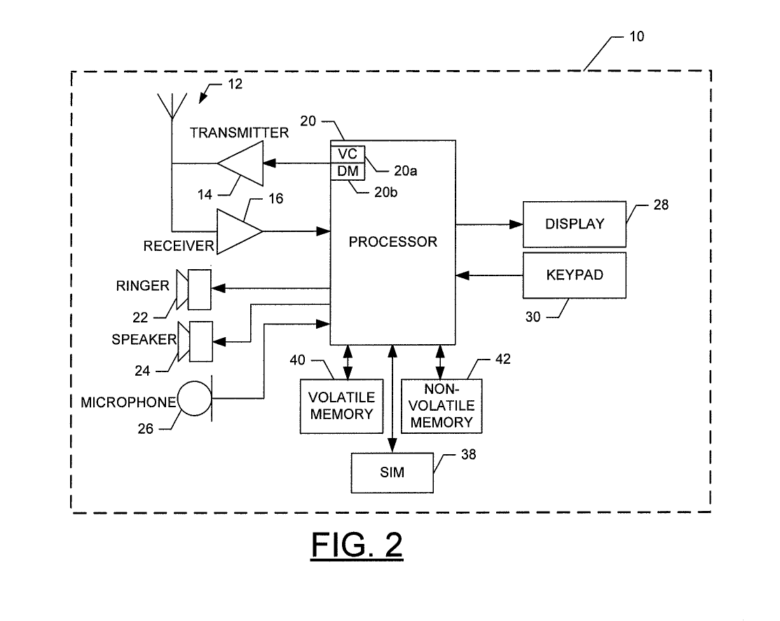

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs (e.g., applications), which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus. In some example embodiments, the user interface may comprise content display and touch display (e.g., a touch display user interface). As used herein for embodiments of the present invention, a “touch display” or “touch display user interface” may refer to either the entire touch display user interface or just the portion dedicated to user input.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a projected capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

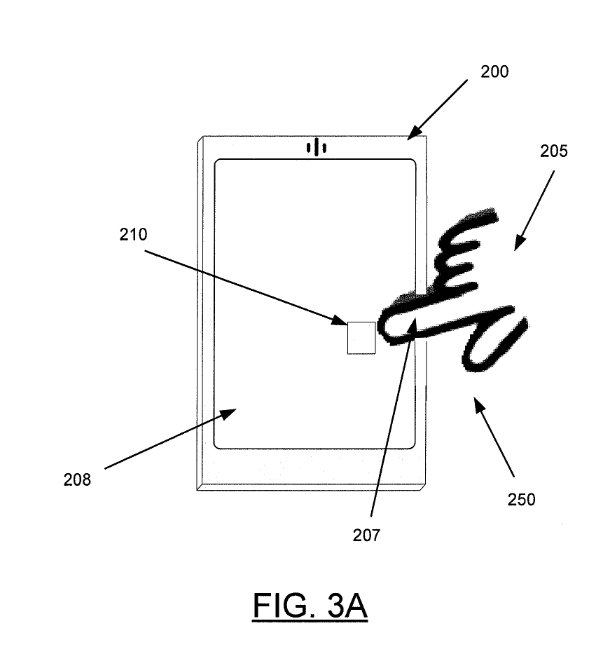

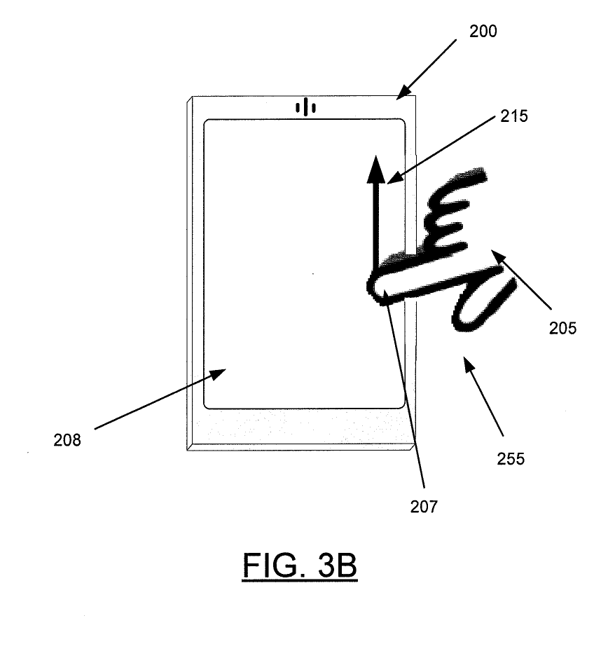

The processor 110 and/or UI control circuitry 122 may be configured to receive user input and/or an indication of user input. The user input may indicate a user's desire for the apparatus 102 to perform a designated function (e.g., run an application, load a website, etc.). In some embodiments, the different components and/or abilities of the apparatus 102 may determine the types of functions able to be performed. Some examples of gestures are shown in FIGS. 3A and 3B.

FIG. 3A illustrates an example user input 250 for an apparatus 200 with a touch display 208 (e.g., user interface 116). In the depicted embodiment, a user 205 positions their finger 207 on or near the display, and particularly, on or near a portion 210 of the display. In some embodiments, the portion 210 of the display may correspond to a pre-determined point that is associated with a desired function. In other words, the portion 210 may correlate to a function that can be performed by the apparatus 200 (e.g., an icon representing an application). For example, the portion 210 may correlate to an application that grants access to the internet. Likewise, the portion 210 may correspond to another function, such as a hyperlink, game application, etc. Thus, by placing a finger 207 on or near the portion 210 (e.g., “touching”), the user 205 is indicating a desire for the apparatus 200 to perform that related function (e.g., open the internet, access the linked website, launch the game application, etc.). Based on the user input detected by the user interface 116, the processor 110 and/or UI control circuitry 122 may respond, causing performance of the desired function.

FIG. 3B illustrates another example user input 255, often referred to as a “swipe gesture”, for an apparatus 200 with a touch display 208 (e.g., user interface 116). In the depicted embodiment, a user 205 positions a finger 207 on or near a portion of the display. The user 205 may slide their finger 207 along the display 208 (e.g., along arrow 215). In some embodiments, a user may slide their finger in a generally linear direction to define a swipe gesture. This user input often corresponds to a user's desire to “scroll” or move the display to show displayed content that may be currently off the display. Based on the user input detected by the user interface 116, the processor 110 and/or UI control circuitry 122 may respond (e.g., scrolling the previously un-displayed content onto the display for the user). Though the above example details functionality of scrolling being correlated with a “swipe gesture”, such a gesture/input is not limited to functionality related to scrolling and, in some embodiments, such as some embodiments of the present invention, the “swipe gesture” may correspond to any type of functionality. For example, the processor 110 and/or UI control circuitry 122 may be configured to display a list of currently active applications in response to receiving a “swipe gesture.”

As indicated above, there are many types of user inputs that are recognizable by apparatus 102. Some additional known user inputs include pinching or reverse pinching for zooming out or zooming in, respectively. Though the above description provides examples of typical user inputs, embodiments of the present invention can be utilized with any type of user input. In that same vein, though the above detailed user inputs are described with respect to a touch display, embodiments of the present invention may be utilized with apparatus 102 that contains designated user input components, such as buttons or scroll bars.

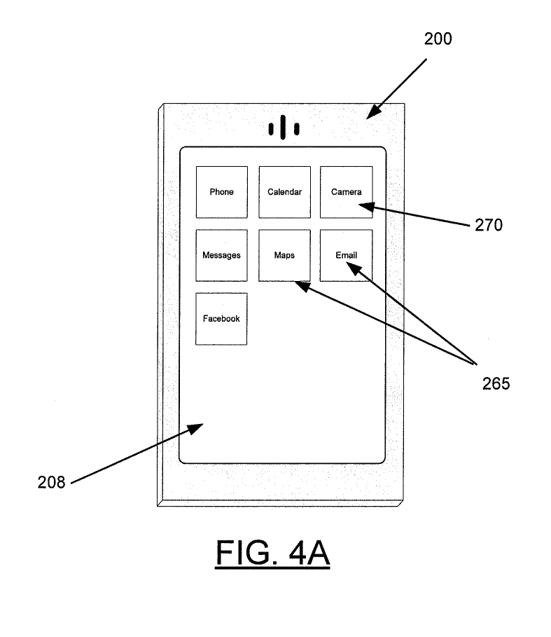

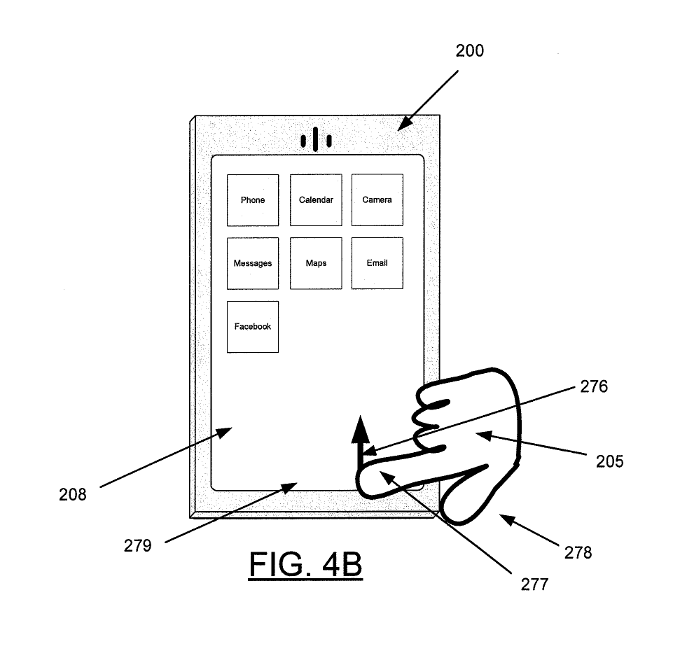

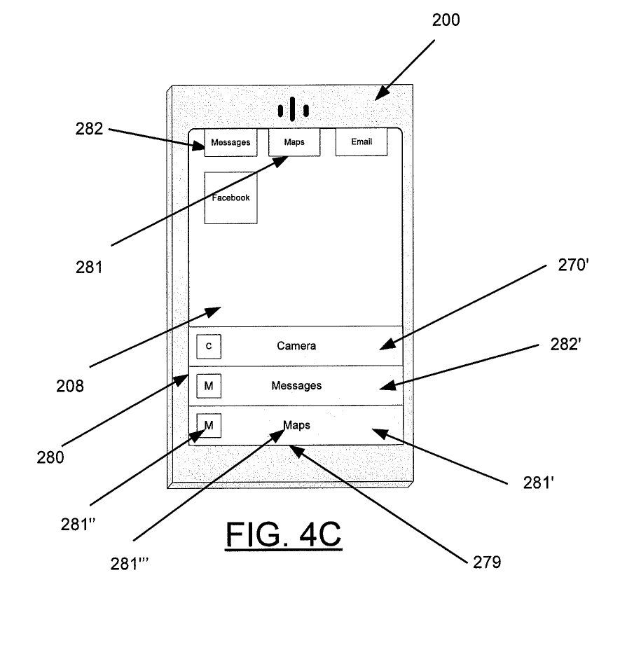

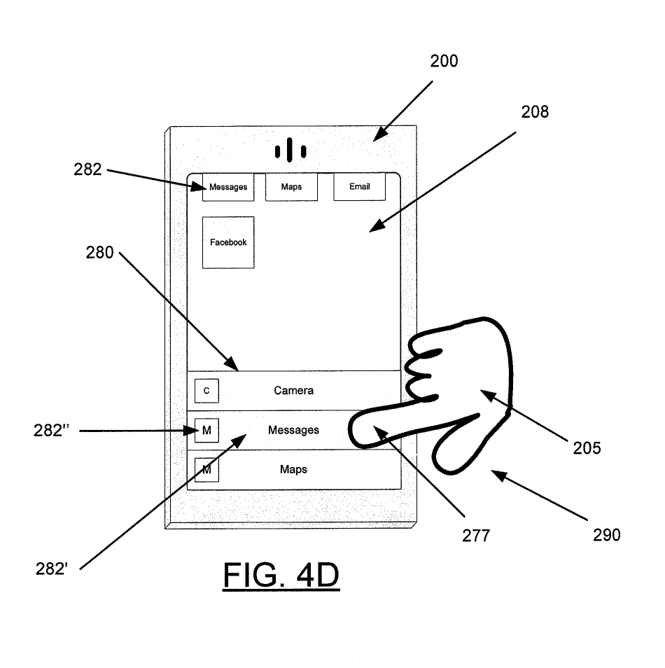

As noted herein, in some embodiments, the apparatus 102, including the processor 110 and/or UI control circuitry 122, may be configured to perform functionality, such as opening, running, and/or executing an application. In some embodiments, the apparatus 102 may be configured to display an arrangement of icons that represent applications for which the apparatus 102 is configured to perform functionality for. Often, this display is referred to as a “homescreen”. With reference to FIG. 4A, an example apparatus 200 (e.g., apparatus 102) comprises a display 208 (e.g., user interface 116) that is currently displaying a homescreen. In the depicted embodiment, the display 208 details icons 265 that each represent corresponding applications. For example, a camera icon 270 represents an application that includes functionality for taking a photograph, such as taking a photograph with a camera that may be in communication with the processor of the apparatus 200.

In some embodiments, a user may perform a user input (e.g., a touch input) directed at least one of the icons shown on the display of the apparatus 102. Such a user input may indicate the user's desire to open the corresponding application (e.g., gain access to the functionality of the application). In response to receiving the user input, the apparatus 102 may be configured to provide a user access to functionality within the application (e.g., open the application).

In some cases, a user may wish to return to the homescreen. While in some embodiments, the user may close out of the first application to return to the homescreen, the apparatus 102 may, in some embodiments, be configured to allow a user to return to the homescreen without closing out of the first application. This may cause the first application to remain active (e.g., continue running) while the user is viewing the homescreen. In some cases, an application is referred to as running in the “background” when a user is not actively viewing the application, but the application is still currently active.

Moreover, in some embodiments, the apparatus 102 may be configured to allow the user to access another application, even while the first application is still running (e.g., currently active). As such, in some embodiments, the apparatus 102 may be configured to run/execute more than one application at the same time. For example, with reference to FIG. 4A, the apparatus 200 may be currently running the camera application, the messaging application, and the maps application, even though the homescreen is currently displayed and there is no additional indication that these applications are running. Though the above description details one example of opening and running multiple applications at the same time, other methods may be employed to enable running of multiple applications, and embodiments of the present invention are not meant to be limited to the method described above.

Users may wish to view and/or manage certain functions or applications on their mobile computing device, often focusing on the applications that are currently active on the device. This may correlate to a user's desire to easily switch between active applications or, in some cases, close active applications that may be dominating processing power of the device. In particular, as noted above, example apparatuses, such as apparatus 102, may be configured to run more than one application at the same time. In some embodiments, the user may wish to access one or more of the currently active applications. For example, the user may wish to manage (e.g., close, delete, focus on, open, etc.) one or more of the currently active applications. In some cases, a user may wish to easily switch between currently active applications.

As noted above, however, apparatuses, such as apparatus 102, may store and/or have access to a great number of applications or functions and, considering the small form factor that limits the space available for displaying of applications, other available applications may be hidden (e.g., shown on a different homescreen). As such, viewing of all available applications, including all currently active applications, is often not possible. Thus, a user may wish to conserve the display space and/or focus on currently active applications.

Additionally, in some cases, the user may wish to control the current performance rate of the apparatus 102 by managing one or more of the currently active applications. In particular, with limited processing power for the processor 110, added requirements for processing power (such as from running multiple applications) may lead to detrimental or slower performance of the apparatus 102 (e.g., an application may load slowly or a function may execute slowly). Similarly, a specific application may require downloading or access to large files, which may require added processing power and, thus, may also cause the performance rate of the apparatus 102 to slow. As such, since performance rate of the apparatus 102 is often important to a user, the user may wish to access the currently active applications in order to affect the performance rate of the apparatus. For example, the user may wish to close a currently active application that may be affecting performance of the apparatus.

With the ability to view and perform other functionality while one or more applications are currently active on an apparatus (e.g., apparatus 102), however, it may be difficult for a user to identify which applications are currently active on an apparatus. For example, with reference to FIG. 4A, even though the apparatus 200 is currently running a number of applications (e.g., a camera application, a messaging application, and a maps application), no indication of the current activity of these applications is provided for on the currently displayed homescreen.

Moreover, in some embodiments, apparatuses, such as apparatus 200, may allow for multiple homescreens for the display of many different applications. While some apparatuses may be configured to display a feature on each icon that indicates that the corresponding application is currently running, with multiple screens and many different applications, a more user-friendly and better organized display of the currently active applications is desired. As such, embodiments of the present invention provide methods and apparatuses for displaying a list of currently active applications.

FIGS. 4A-4C illustrate an example method for displaying a list of currently active applications on an apparatus 200. While the following description details use of specific user inputs and depicts specific lists of currently active applications, such a description is used for explanatory purposes only and is not meant to limit embodiments of the present invention.

As noted above, FIG. 4A depicts an apparatus 200 with a display 208 that details a homescreen. The display 208 of the apparatus 200 depicts icons 265 that each correspond to an application that the apparatus 200 is configured to run/execute. As noted above, some of the applications may be currently active (e.g., running in the background).

In some embodiments, the apparatus 102 may be configured to receive user input that indicates a user's desire to view a list of currently active applications. In some embodiments, the apparatus 102 may be configured to receive user input defining a swipe gesture originating from an edge of the display. For example, with reference to FIG. 4B, a user 205 may position their finger 277 near an edge (e.g., the bottom edge 279) of the display 208. The user may then perform a “swipe” gesture 278 by sliding their finger 207 along the display 208 (e.g., along arrow 276). In some embodiments, the user may perform the swipe gesture from a different edge of the display 208. The apparatus 102 may receive such example user input and recognize that the user input indicates a user's desire to view a list of currently active applications.

In some embodiments, the apparatus 102 may be configured to determine which applications are currently running. For example, the apparatus 102 may be configured to query the processor 110 to determine which applications are currently active. Additionally or alternatively, the apparatus 102 may automatically keep track of which applications are active as they open. For example, the apparatus 102 may be configured to store an indication when an application opens and remove the indication when the application closes. Thus, the apparatus 102 may query the stored indications to determine which applications are currently active.

In some embodiments, the apparatus 102 may be configured to determine at least one characteristic about each currently active application. Some examples of characteristics that the apparatus 102 may be configured to determine are the name of the application, the amount of time that has elapsed since the application has last been used by the user, the total time that has elapsed since the application was first opened, the frequency in which the application has been used over an amount of time, and the amount of processing power currently being used by the application. These example characteristics are just some of the characteristics that the apparatus 102 may be configured to determine, and this list of is not meant to be exhaustive, as embodiments of the present invention may provide an apparatus 102 configured to determine other characteristics of an application.

In some embodiments, the apparatus 102, including the processor 110, may be configured to determine a list of applications. In some embodiments, the apparatus 102 may be configured to determine a list of applications comprising at least one currently active application. Likewise, in some embodiments, the apparatus 102 may be configured to determine a list of currently active applications.

In some embodiments, the apparatus 102 may be configured to rank each currently active application according to a predefined order. Additionally, the predefined order may depend at least in part on a determined characteristic of the currently active applications. For example, the predefined order may depend at least in part on at least one of the alphabetical order of the applications, the order of recent use of the applications, order of frequency of use of the applications, the order of active running time of the applications, or the order of processing power used by the applications. In such embodiments, the apparatus 102 may be configured to determine the list of applications based at least in part on the ranking of the currently active applications. For example, the apparatus 102 may assign a rank (e.g., 1 to 100) for each currently active application based on at least one of a common characteristic of the currently active applications (e.g., the time elapsed since the last use of the application by the user). Then, the apparatus 102 may determine a list of applications that orders the currently used applications from lowest to highest (e.g., 1 to 100), with the first application having the lowest ranking (e.g., 1) and corresponding to the application with the least amount of time elapsed since last use by the user and with the last application having the highest ranking (e.g., 100) and corresponding to the application with most amount of time elapsed since last use by the user. Though the above description uses a ranking of lowest to highest, with an example of 1 to 100, other ranking systems (e.g., highest to lowest), with other value indicators (e.g., letters, weights, etc.), may be used.

In some embodiments, the apparatus 102 may be configured to cause display of the list of applications. In some embodiments, the apparatus 102 may be configured to cause display of the list of applications in response to receiving the user input. For example, with reference to FIG. 4C, in response to receiving the user input 278 (shown in FIG. 4B), the apparatus 200 may be configured to display a list of applications 280.

In some embodiments, the list of applications may comprise at least one currently active application. In the depicted embodiment, the list of applications 280 corresponds to the applications that are currently active. In particular, the list of applications 280 includes the camera application, the messaging application, and the map application (which were previously noted as being currently active).

In some embodiments, the apparatus 102 may be configured to cause display of the list of applications by causing the list of applications to extend from an edge of the display. In the depicted embodiment, the list of applications 280 extends upwardly from the bottom edge 279 of the display 208. In some embodiments, the apparatus 102 may be configured to cause display of the list of applications from the edge of the display in which the user input originated (e.g., the bottom edge 279 which corresponds to the edge in which user input 278 originated). In some embodiments, performing the swipe gesture from a different edge of the display 208 may result in the list of applications being displayed relative to the edge in which the user performed the swipe gesture.

In some embodiments, the apparatus 102 is configured to cause display of the list of applications by causing display of at least one first application above at least one second application. For example, the apparatus 102 may be configured to cause display of the list of applications in a top to bottom list format. In the depicted embodiment, the list of applications 280 is displayed with a representation of the camera application 270′ first, a representation of the messaging application 282′ second, and a representation of the maps application 281′ third, from top to bottom.

Along these same lines, the apparatus 102 may be configured to cause display of the list of applications according to a predefined order, such as any of the predefined orders described herein. Similarly, in some embodiments, the apparatus 102 may be configured to cause display of the list of applications based at least in part on the ranking of each currently active application as described herein. In some embodiments, the apparatus 102 may be configured to cause display of the list of applications in a predefined order that comprise at least one of alphabetical order of the applications, order of recent use of the applications, order of frequency of use of the applications, order of active running time of the applications, or order of processing power used by the applications. For example, in the depicted embodiment, the apparatus 200 may have caused display of the list of applications 280 in order of recent use of the applications in an instance in which the camera application was mostly recently used, the messaging application was the next most recently used, and the maps application was after the messaging application in order of most recent use.

In some embodiments, the apparatus 102 may be configured to cause display of a predetermined number of applications in the list of applications. In some embodiments, the apparatus 102 may be configured to cause display of a predetermined number of currently active applications based at least in part on the ranking of each currently active application. For example, in embodiments in which the apparatus is configured to rank the currently active applications based on at least one characteristic, the apparatus may also be configured to cause display of a predetermined number of lowest ranked currently active applications in the list of applications (e.g., currently active applications ranked 1 to 3). In a particular example, the apparatus may have five currently active applications, applications A, B, C, D, and E. In such an embodiment, the apparatus may be configured to cause display of the top three currently active applications as the list of applications. Moreover, such a ranking may be based on the alphabetical order of the applications. Thus, in such an embodiment, the apparatus would cause display of applications A, B, and C in that order as the list of applications. Though the above described example uses alphabetical ordering and limits the predetermined number of currently active applications to display to three, other embodiments may use different ordering and/or cause display of a different predetermined number of currently active applications.

In some embodiments, the apparatus 102 may be configured to cause display of a list of applications by causing display of a feature corresponding to an application in the list of applications. For example, in the depicted embodiment, the list of applications 280 includes a list bar that corresponds to each listed application (e.g., the bar 282′ that corresponds to the messaging application 282). In some embodiments, the apparatus 102 may be configured to cause display of a list icon corresponding to each application in the list of applications. For example, in the depicted embodiment, the list of applications 280 includes a list icon that corresponds to each listed application (e.g., the icon 281″ that corresponds to the maps application 281). Additionally, in some embodiments, the apparatus 102 may be configured to cause display of a list title corresponding to each application in the list of applications. For example, in the depicted embodiment, the list of applications 280 includes a list title that corresponds to each listed application (e.g., the title 281″, “Maps”, that corresponds to the maps application 281). Additionally, in some embodiments, the apparatus 102 may be configured to cause display of a list design element corresponding to each application in the list of applications. In some embodiments, the list of applications may include a list design element that corresponds to each listed application. For example, the list bar 270′ may include a design element (not shown) that corresponds to a design element of the camera application icon 270 (e.g., a representation of a camera lens).

In some embodiments, the apparatus 102 may be configured to cause display of any or all of the features corresponding to an application in the list of applications in a predetermined color. Additionally, in some embodiments, the predetermined color may correlate (e.g., substantially match) a color of an icon representing the corresponding application. For example, in the depicted embodiment, the list bar 281′ corresponding to the maps application has a color that substantially matches the color of the maps application icon 281.

Similarly, in some embodiments, the apparatus 102 may be configured to cause display of any or all of the features corresponding to an application in the list of applications in a predetermined transparency. Additionally, in some embodiments, the predetermined transparency may be less than a transparency of an icon representing the corresponding application. For example, in the depicted embodiment, the list bar 281′ corresponding to the maps application has a transparency that is less than the transparency of the maps application icon 281. In some embodiments, the features of the list of applications may comprise a transparency that is approximately 50% of the transparency of the icons representing the corresponding applications.

In some embodiments, the apparatus 102 may be configured to receive a second user input that indicates a user's desire to select at least one of the applications in the list of applications. In some embodiments, the apparatus 102 may be configured to receive a second user input that indicates a selection of at least one of the list bars in the list of applications. Additionally or alternatively, the apparatus 102 may be configured to receive the second user input toward any feature (e.g., list bar, list icon, list title, etc.) corresponding to an application in the list of applications. For example, with reference to apparatus 200 shown in FIG. 4D, a user 205 may perform a second user input 290 (e.g., a touch input) with a finger 277 that is directed at list bar 282′.

In some embodiments, in response to receiving the second user input, the apparatus 102 may be configured to cause execution of a function associated with the application corresponding to the feature selected by the second user input. In some embodiments, the apparatus 102 may be configured to cause execution of a function associated with the application corresponding to the selected feature (e.g., list bar, list icon, list title, etc.). As used herein with response to the second user input, the apparatus 102 may be configured to execute a function (e.g., initiate a function of the application, open the application, execute a function of the application, close the application, delete the application, etc.) when causing execution of a function associated with the application corresponding to the feature selected by the second user input. For example, with reference to FIG. 4D, the apparatus 102 may be configured to open the messaging application in response to receiving the user input 290 directed toward the list bar 282′

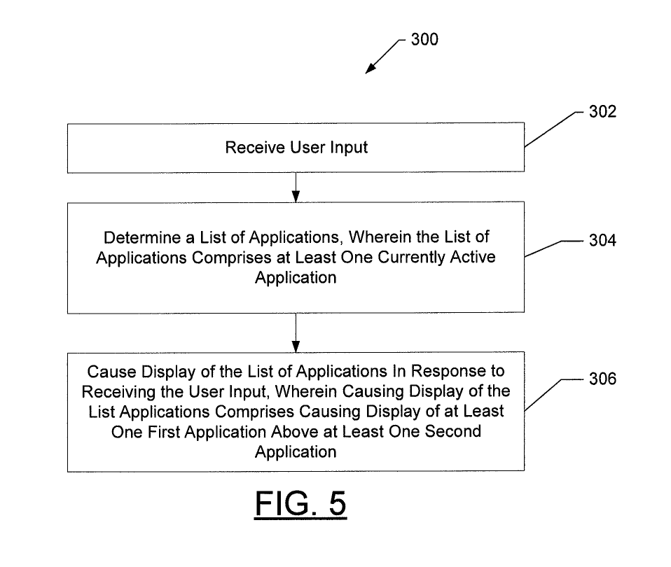

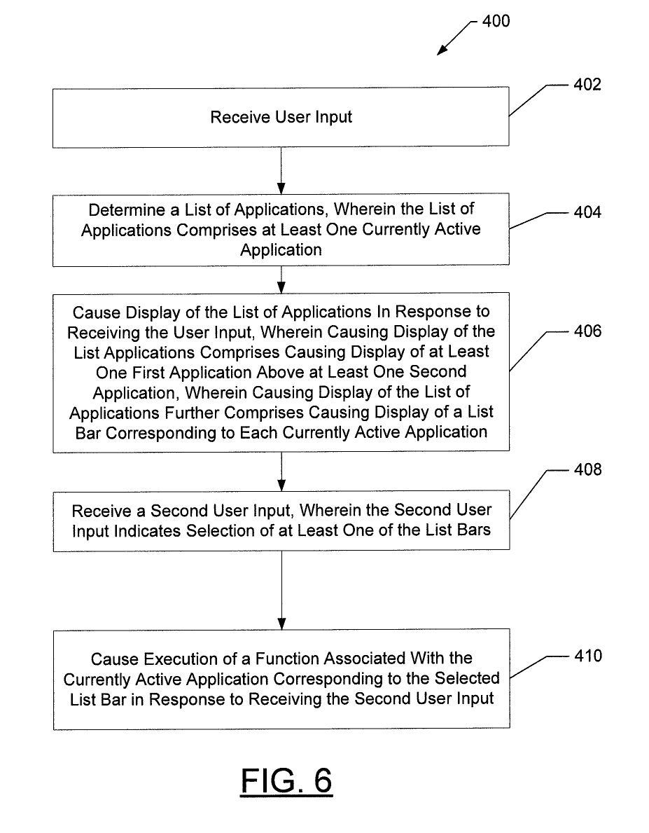

Embodiments of the present invention provide methods, apparatus and computer program products for displaying a list of currently active applications. Various examples of the operations performed in accordance with embodiments of the present invention will now be provided with reference to FIGS. 5-6.

FIG. 5 illustrates a flowchart according to an example method for displaying a list of currently active applications according to an example embodiment 300. The operations illustrated in and described with respect to FIG. 5 may, for example, be performed by, with the assistance of, and/or under the control of one or more of the processor 110, memory 112, communication interface 114, user interface 116, or UI control circuitry 122. Operation 302 may comprise receiving user input. The processor 110, user interface 116, and/or UI control circuitry 122 may, for example, provide means for performing operation 302. Operation 304 may comprise determining a list of applications, wherein the list of applications comprises at least one currently active application. The processor 110 may, for example, provide means for performing operation 304. Operation 306 may comprise causing display of the list of applications in response to receiving the user input, wherein causing display of the list of applications comprises causing display of at least one first application above at least one second application. The processor 110, user interface 116, and/or UI control circuitry 122 may, for example, provide means for performing operation 306.

FIG. 6 illustrates a flowchart according to another example method for displaying a list of currently active applications according to an example embodiment 400. The operations illustrated in and described with respect to FIG. 6 may, for example, be performed by, with the assistance of, and/or under the control of one or more of the processor 110, memory 112, communication interface 114, user interface 116, or UI control circuitry 122. Operation 402 may comprise receiving user input. The processor 110, user interface 116, and/or UI control circuitry 122 may, for example, provide means for performing operation 402. Operation 404 may comprise determining a list of applications, wherein the list of applications comprises at least one currently active application. The processor 110 may, for example, provide means for performing operation 404. Operation 406 may comprise causing display of the list of applications in response to receiving the user input, wherein causing display of the list of applications comprises causing display of at least one first application above at least one second application, and wherein causing display of the list of applications further comprises causing display of a list bar corresponding to each currently active application. The processor 110, user interface 116, and/or UI control circuitry 122 may, for example, provide means for performing operation 406.

Operation 408 may comprise receiving a second user input, wherein the second user input indicates selection of at least one of the list bars. The processor 110, user interface 116, and/or UI control circuitry 122 may, for example, provide means for performing operation 408. Operation 410 may comprise causing execution of a function associated with the currently active application corresponding to the selected list bar in response to receiving the second user input. The processor 110, user interface 116, and/or UI control circuitry 122 may, for example, provide means for performing operation 410.

FIGS. 5-6 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving user input;
determining, by a processor, a list of applications, wherein the list of applications comprises at least one currently active application; and
causing display of the list of applications in response to receiving the user input, wherein causing display of the list of applications comprises causing display of at least one first application above at least one second application.

2. The method according to claim 1, wherein the user input defines a swipe gesture originating from an edge of a display.

3. The method according to claim 1, wherein determining the list of applications comprises ranking each currently active application according to a predefined order, and wherein causing display of the list of applications comprises causing display of the list of applications in the predefined order.

4. The method according to claim 3, wherein the predefined order comprises at least one of alphabetical order of the applications, order of recent use of the applications, order of active running time of the applications, order of frequency of use of the applications, or order of processing power used by the applications.

5. The method according to claim 1, wherein determining the list of applications comprises ranking each currently active application according to a predefined order, and wherein the list of applications comprises a predetermined number of currently active applications based at least in part on the ranking of each currently active application.

6. The method according to claim 5, wherein the predefined order comprises at least one of alphabetical order of the applications, order of recent use of the applications, order of active running time of the applications, order of frequency of use of the applications, or order of processing power used by the applications.

7. The method according to claim 1, wherein causing display of the list of applications comprises causing display of a list bar corresponding to each currently active application.

8. The method according to claim 7, wherein each list bar comprises a color that matches a color of an icon representing the corresponding currently active application.

9. The method according to claim 7, wherein each list bar comprises a transparency that is less than a transparency of an icon representing the corresponding currently active application.

10. The method according to claim 7 further comprising:
receiving a second user input, wherein the second user input indicates selection of at least one of the list bars; and
causing execution of a function associated with the currently active application corresponding to the selected list bar in response to receiving the second user input.

11. The method according to claim 2, wherein the user input defines a swipe gesture originating from the bottom edge of the display.

12. An apparatus comprising a processor and a memory including computer program code, the memory and the computer program code configured to, with the processor, cause the apparatus to:
receive user input;
determine a list of applications, wherein the list of applications comprises at least one currently active application; and
cause display of the list of applications in response to receiving the user input, wherein causing display of the list of applications comprises causing display of at least one first application above at least one second application

13. The apparatus of claim 12, wherein the user input defines a swipe gesture originating from an edge of a display.

14. The apparatus according to claim 12, wherein the memory and the computer program code are further configured to, with the processor, cause the apparatus to determine the list of applications by ranking each currently active application according to a predefined order, and to cause display of the list of applications by causing display of the list of applications in the predefined order.

15. The apparatus according to claim 14, wherein the predefined order comprises at least one of alphabetical order of the applications, order of recent use of the applications, order of active running time of the applications, order of frequency of use of the applications, or order of processing power used by the applications.

16. The apparatus according to claim 12, wherein the memory and the computer program code are further configured to, with the processor, cause the apparatus to determine the list of applications by ranking each currently active application according to a predefined order, and wherein the list of applications comprises a predetermined number of currently active applications based at least in part on the ranking of each currently active application.

17. The apparatus according to claim 16, wherein the predefined order comprises at least one of alphabetical order of the applications, order of recent use of the applications, order of active running time of the applications, order of frequency of use of the applications, or order of processing power used by the applications.

18. The apparatus according to claim 12, wherein the memory and the computer program code are further configured to, with the processor, cause the apparatus to cause display of the list of applications by causing display of a list icon corresponding to each currently active application.

19. Computer program product comprising a non-transitory computer readable medium having program code portions means stored thereon, the program code portions being a computer readable medium and configured when said program product is run on a computer or network device, to:
receive user input;
determine a list of applications, wherein the list of applications comprises at least one currently active application; and
cause display of the list of applications in response to receiving the user input, wherein causing display of the list of applications comprises causing display of at least one first application above at least one second application.

20. The computer program product of claim 19, wherein the user input defines a swipe gesture originating from an edge of a display.
